(19) United States
(12) Patent Application Publication
(10) Pub. No.: US 2021/0078647 A1
(43) Pub. Date: Mar. 18, 2021

(54) Tailgate Gap Cover

(71) Applicants: Russell L. Dunford, Brownsboro, AL (US); AnnMarie K. Dunford, Brownsboro, AL (US); Abigail C. Dunford, Brownsboro, AL (US)

(72) Inventors: Russell L. Dunford, Brownsboro, AL (US); AnnMarie K. Dunford, Brownsboro, AL (US); Abigail C. Dunford, Brownsboro, AL (US)

(21) Appl. No.: 16/893,722

(22) Filed: Jun. 5, 2020

Related U.S. Application Data
(60) Provisional application No. 62/860,210, filed on Jun. 11, 2019.

(51) Int. Cl. B62D 33/027

(52) U.S. Cl. CPC B62D 33/0273

(57) ABSTRACT

A tailgate gap cover has two panels attached to one another through a hinged connection. A gate panel is fixable to the tailgate with the hinged connection parallel with the bottom inside edge of the tailgate and a bed panel is able to slide on the cargo bed so that, when the tailgate is moved from the upright, closed position into the horizontal, open position, the gate panel pulls on the bed panel slide a portion of the bed panel over the gap between the cargo bed and the tailgate.

### BACKGROUND OF THE INVENTION

### Field of the Invention

The present invention relates to devices used to cover a gap between a tailgate and a bed of a truck, such as a pickup truck, station wagon, or SUV.

### Description of Related Art

Pickup trucks typically have tailgates that swing from a raised, upright position to a lowered, horizontal position. Other types of vehicles, such as station wagons, vans, and SUVs may also be equipped with such swingable tailgates. Generally, all swingable tailgates create a gap between the end of the vehicle bed and the tailgate as the tailgate is lowered. This may provide an obstacle when loading or unloading heavy articles, especially articles with extensions that may become lodged in the gap. Additionally, gravel, sand, dirt, and other particulate matter carried on truck beds oftentimes falls into the gap, causing the tailgate movement to jam or be damaged. Vehicles with tailgates and backup cameras, radar sensors, and/or other electronic equipment mounted to the back bumper or other surface below the tailgate usually have wires that can be damaged when gravel or other particles fall into or through the gap.

A number of solutions to the problems associated with the gap between the open tailgate and vehicle bed have been described. For example, U.S. Pat. No. 5,188,415 describes a pivotable tailgate connector with a swingable tailgate fixed to the rear of a truck bed that spans the gap between the bed and the tailgate when the tailgate is lowered. The connector is positioned at the rear of the truck bed contiguous to the tailgate so that it pivots from a horizontal to a vertical position as the tailgate is raised. U.S. Pat. No. 5,904,391 describes a similar tailgate cover consisting of a flap running along the gap and connected to the rear end of the bed by a hinge. One edge of the flap is flush with the end of the bed and the other edge overlaps the bottom of the gate when the gate is open. When the gate is closed, the edge overlapping the gate is pushed upward and the edge facing the bed flips downward within the gap.

U.S. Pat. No. 5,664,822 describes a tailgate gap cover for attachment to the bed and tailgate of a pickup truck. Interconnected panels cover the gap and parts of the tailgate and bed on ether side of he gap. The panel covering the gap unfolds when the tailgate is in the horizontal open position, and folds when the tailgate vertical closed position. U.S. Pat. No. 6,640,278 describes a tailgate with a panel that extends through an aperture and is attached to the vehicle body. The panel simultaneously pivots relative to the vehicle body and slides relative to the tailgate as the tailgate is opened and closed to allow the panel to cover at least a portion of a gap between the vehicle body and the tailgate when the tailgate is an open position.

U.S. Pat. No. 8,459,716 describes a removable tailgate gap cover having a cover plate fixed to a support bar. The support bar is shaped to fit into the gap an attach magnetically to the rear end of the truck bed with cover plate covering the gap. U.S. Pat. No. 9,016,753 describes a tailgate gap cover comprising a flexible and compressible flap attached to a mounting rail that is mounted to the bed of a truck An opposite free edge of the flap is releasably attached to the tailgate using fasteners.

Various drawbacks are associated with existing tailgate gap covers, including those described above. In some cases, the movement of the cover when the gate is closed pushes a part of the cover into a space inside the tailgate. Portions of the covers fixed to the truck bed may result in an uneven surface at the rear end of the truck bed and limited gap space when the tailgate is closed may not allow attachment of a cover to the rear end of the bed. Flexible materials requiring extreme angles of folding may be degraded by ultraviolet light over time and may fail from repeated folding. Some do not allow the tailgate to be closed unless the cover is removed while other require tailgate replacement or the addition of mounting rails or other modifications to the truck bed.

### BRIEF SUMMARY OF THE INVENTION

The present invention provides for a tailgate gap cover comprising tailgate and cargo bed panels attached to one another through a hinged connection. The gate panel is fixable to the tailgate so that the hinged connection runs parallel with, and in apposition to, the edges of the bottom of the tailgate and rear end of the cargo bed when the tailgate is closed. The bed panel is able to slide on the cargo bed so that, when the tailgate is lowered from the upright, closed position into the horizontal, open position, the gate panel pulls on the cargo bed panel through the hinge to slide the cargo bed panel relative to the cargo bed and cover the gap between the cargo bed and the tailgate. When the tailgate is raised from the horizontal, open position to the upright, closed position, the gate panel pushes on the cargo bed panel through the hinge to slide the cargo bed panel into the cargo bed.

The features of the present invention provide for a durable tailgate gap cover that prevents loose materials from entering into the gap between the tailgate and truck bed whether the tailgate is closed or open and without interfering with the normal use of the tailgate, even when the cargo bed is fully loaded. The gap cover is simple to install without modification to the truck bed, resistant to the elements, and attachable to the tailgate while it is in place on the vehicle. The gap cover provides for retrofit to any of a wide variety of existing and new vehicles available that have a tailgate hinge area. Various other objectives and advantages of the tailgate gap cover will become apparent to those skilled in the art with a more detailed description as set presented below.

### BRIEF DESCRIPTION OF THE DRAWINGS

The elements of the drawings are not necessarily to scale relative to each other, with emphasis placed instead upon clearly illustrating the principles of the disclosure. Like reference numerals designate corresponding parts throughout the several views of the drawings in which:

FIGS. 1A and B are side cross-sectional views of a rear end of a truck bed comprising a hinged tailgate with the tailgate closed and open;

FIGS. 2 A and B are side cross-sectional views of an embodiment of a tailgate gap cover attached to a tailgate with the tailgate closed and open;

FIG. 3 is a top view of a first embodiment of a tailgate gap cover;

FIG. 4 shows an end view and a top view of a second embodiment of a tailgate gap cover; and

FIG. 5 shows an end view and a top view of a third embodiment of a tailgate gap cover.

### DETAILED DESCRIPTION OF THE INVENTION

Selected embodiments are explained with reference to the drawings. It will be apparent from this disclosure that the descriptions of the selected embodiments are provided for illustration only and not for the purpose of limiting the invention as defined by the appended claims and their equivalents.

All art specific terms used herein are intended to have their art-accepted meanings in the context of the description unless otherwise indicated. All non art specific terms are intended to have their plain language meaning in the context of the description unless otherwise indicated.

Vehicles such as pickup trucks, station wagons, and SUVs comprise cargo beds. The term “truck bed” is used interchangeably with “cargo bed” to indicate the horizontal surface onto which cargo is placed and for which a provides means for retaining cargo on and in the cargo bed.

Unless specified otherwise, directions such as “forward,” “rear,” and “into” are in reference to the orientation of a cargo bed. Unless specified otherwise, “bottom,” as used with respect to a tailgate refers to the bottom of the tailgate when it is in its upright, closed position. Unless specified otherwise, “inside surfaces,” as used with respect to a cargo bed and a tailgate refer to surfaces that are facing the area within the cargo bed when the tailgate is closed.

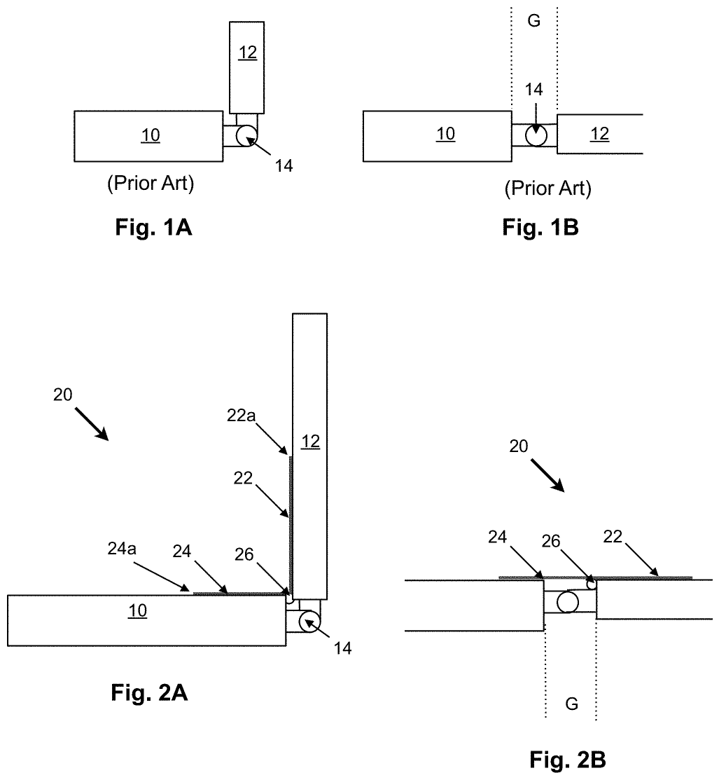

FIG. 1 is a side cross-sectional view of a rear end of a truck bed comprising a truck bed, or cargo bed, (10) and a tailgate (12) connected by a hinge (14). When the tailgate (12) is closed, no significant gap (G) exists between the rear end of the truck bed (10) and the tailgate (12). When the tailgate (12) of a standard pickup truck, for example, is lowered, a substantial gap (G) forms between the truck bed (10) and the tailgate (12). Such a gap (G) may exist when other types of tailgate structures hinged in a similar manner are lowered. A substantial gap (G) may span a distance of from 1.5 cm to 10 cm, for example. If gravel, sand, dirt, grit, stones, pebbles, aggregate or similar material is loaded into the cargo bed (10), opening the tailgate (12) allows the material to fall into the gap (G).

FIG. 2 is a side cross-sectional view of the same truck bed and tailgate as shown in FIG. 1, but with an embodiment of a tailgate gap cover (20) attached to the tailgate (12). The gap cover (20) comprises a gate panel (22) that is fixable to the tailgate (12), a cargo bed, or bed panel (24) that is configured to slide on the cargo bed (10) and a hinged connection (26) connecting the tailgate and bed panels. When the gate panel (22) of the tailgate gap cover (20) is fixed to the tailgate (12) with the hinged connection in apposition to the bottom edge or bottom inside edge of the tailgate (12), the tailgate may be used to slide the bed panel (24) on the cargo bed (10). Moving the tailgate (12) from the upright, closed position to the horizontal, open position results in the movement of the bed panel (24) rearward on the cargo bed (10) so that a portion of the bed panel (22) covers the gap (G) between the rear of the cargo bed (10) and the tailgate (12). Raising the tailgate (12) from the horizontal, open position to the upright, closed position causes the bed panel (24) to slide forward on the cargo bed (10).

The tailgate and bed panels (22,24) are preferably made of a durable material such as steel or a durable composite material comprising carbon fiber that is resistant to degradation by sunlight, oxidation, abrasion, and exposure to the elements. Examples of stainless steel thicknesses suitable for the tailgate and bed panels may include 7 gage, 10 gage, 11 gage, and 12 gage. Other metal alloys and other materials such as aluminum may also be suitable materials from which to make the tailgate and bed panels (22,24).

An advantage of making the tailgate and bed panels from a relatively strong metal alloy is that the thickness of the material may be minimized, which allows the bed panel (24) to more easily slide under neath a cargo of loose materials such as gravel, sand, and stone. Many cargo beds are covered by a plastic cargo liner. If a cargo bed (10) is covered by a cargo liner, then the bed panel (24) may be positioned to slide underneath the cargo liner, reducing the effort required to slide the bed panel forward and backward on the cargo bed, even when the cargo bed is loaded with small particulates such as sand.

The size of the hinged connection (26) relative to the dimensions of the tailgate and bed panels are not drawn to scale so that the hinge is more easily seen. The hinged connection is aligned with the bottom edge or bottom inside edge of the tailgate (12) and is preferably at least as wide as the inside of the cargo bed (10) but not wider than the tailgate (12). The hinged connection (26) may comprise a continuous hinge, such as a piano hinge, and may be configured as a butt hinge, parallel hinge, swaging hinge, or stepped hinge. The hinged connection (26) may additionally comprise a flexible material attached to the tailgate and bed panels (22,24) and covering the top surface of the continuous hinge to prevent even very small particles such as dust from penetrating into the hinge. The hinged connection may be connected to the tailgate and bed panels (22,24) by rivets, bolts, screws, welds, or other fixed attachment means. Alternatively, a hinge facing edge of the tailgate (22) and/or bed (24) panel may be shaped to form an integral part of the hinged connection. The hinged connection (26) may optionally be configured to be limited to a movement of 90 degrees or 180 degrees. Because the hinged connection (26) transfers a force from the gate panel (22) to the bed panel (24) to cause the bed panel (24) to slide on the cargo bed (10), the hinged connection (26) is preferably made of a material such as steel or other metal alloy or metal capable of transferring the required force. The hinge connection (26) may be spring loaded to tension the tailgate gap cover (20) toward the open position, which also helps that bed panel (24) maintain close contact with the cargo bed (10).

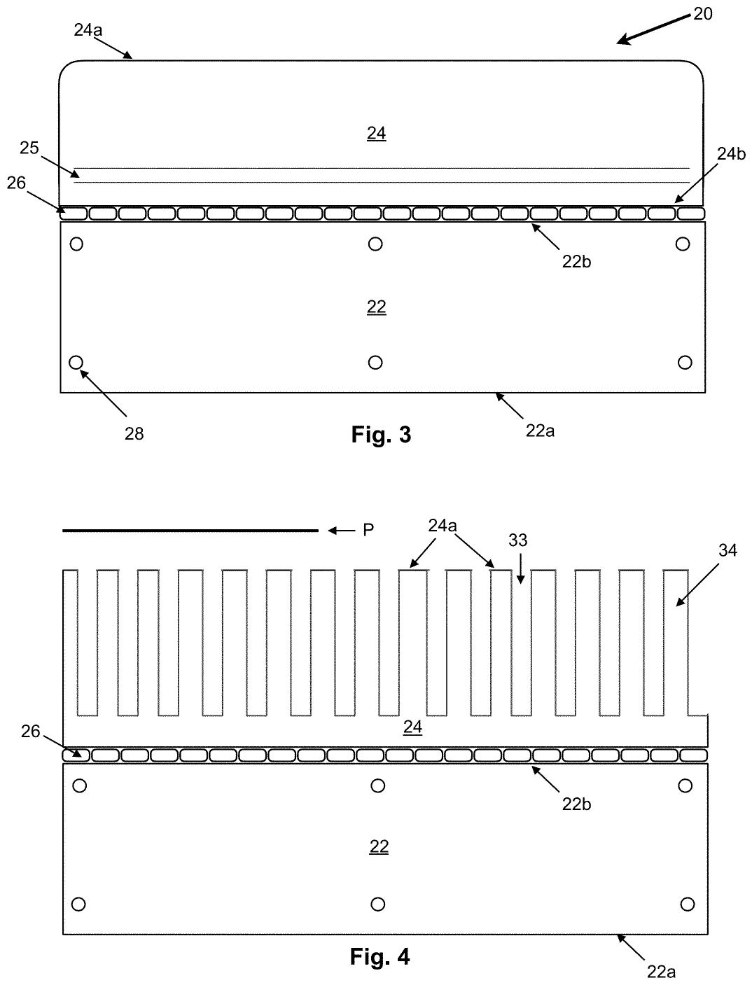

FIG. 3 is a top view of a first embodiment of a tailgate gap cover (20) showing it in an open position. The gate panel (22) shown in the figure comprises a hinge facing edge (22b) and an oppositely facing edge (22a). The gate panel (22) may comprise holes (28) through which screws, bolts, rivets, or similar attachment means may pass for fixed attachment of the gate panel (22) to a tailgate (12). Additionally or alternatively, the gate panel may be fixed to the tailgate by other attachment means such as clamps, hooks, brackets, bolts, screws, adhesives, and any combination of these. The number and spacing of holes (28) as well as the shape of the gate panel may be varied, so long as the hinge facing edge (22b) is sized to connect with the hinged connection (26) along its length. It is preferred that holes (28) are positioned such that, when the gate panel is placed on a desired location on the tailgate (12), the holes (28) align with metal portions of the tailgate comprising existing holes or into which holes may be drilled for screw or bolt attachment. The gate panel (22) being fixed to the tailgate (12) allows the tailgate (12) to act as a lever to move the bed panel (24) forward and backward on the cargo bed (10). The length of the gate panel (22) is preferably shorter than the length of the tailgate, as measured from top to bottom when the tailgate is upright. The length of the gate panel (22) is preferably at least ⅓, and preferably at least ½, the length of the tailgate, as measured from top to bottom when the tailgate is upright.

Still with reference to FIG. 3, the bed panel (24) comprises a hinge facing edge (24b) and an opposite facing leading edge (24a). The corners of the leading edge (24a) shown in the figure are curved to make it easier to slide the bed panel (24) into a cargo bed (10) and the leading edge (24a) may have any of a number of shapes including curved, wedged, and cerated when viewed from above. The bed panel (24) may be completely flat or it may comprise a ridge or ramp (25) aligned parallel with the rear edge of the cargo bed. A ridge (25) may be useful for preventing fine debris from reaching the hinged connection (26), while a ramp (25) sloping downward toward the tailgate (12) may allow the flat surface of the bed panel (24) to ride up and over corrugations in the floor of the cargo bed, if present. The bed panel (24) must be long enough to extend into the cargo bed (10) far enough so that, when the gate panel (22) is fixed to the tailgate (12) and the tailgate is lowered into the open position, a portion of the bed panel (24) completely spans the gap (G) between the rear end of the cargo bed (10) and the bottom of the tailgate (12). The length of the bed panel is preferably at least 8 cm and less than the distance from the rear edge of the bed to wheel wells inside the cargo bed (10).

There is an advantage to a shorter length for the bed panel when the bed is filled with sand or other small particles because, when closing the tailgate, the sand may offer resistance to the forward movement of the bed panel. An optional bed panel cover (not shown) may be attached to the bed in the proximity of the leading edge (24a) of the bed panel when the tailgate (12) is closed. The bed panel cover is configured such that the leading edge conforms to the shape of the bed (e.g. flat or corrugated) and is arranged in parallel with the leading edge (24a) of the bed panel (24). The bed panel cover is shaped to cover at least a portion of the bed panel (24) when the tailgate (12) is closed. and extends away from the bed far enough to create a gap between a wall of the bed panel cover and the cargo bed (10). The wall rising from the leading edge of the bed panel cover may rise at an angle (e.g. 30° or 45°) from the cargo bed. Additionally or optionally, the wall rising from the leading edge of the bed panel cover may have a bullnose profile. For embodiments having a bed panel (24) comprising a spaced slat pattern, as described below, the bed panel cover may comprise one or more supporting elements such as struts that extend down from the top wall of the cover to the bed between the slats of the bed panel.

FIG. 4 is a top view of a second embodiment of a tailgate gap cover (20) showing it in an open position and a portion of an end-on profile view of the bed panel (24). The cargo beds (10) of most pickup trucks comprise corrugations to provide greater strength. The bed panel (24) of tailgate gap cover (20) shown in FIG. 4 comprises a spaced slat pattern in which slats (34) separated by gaps (33) extend forward to the leading edge (24a). The slats (34) are sized to fit between raised portions of the corrugated cargo bed (10). The slats are shown in the figure are of equal length but the lengths of the slats may vary, for example with longer slats (34) in the center and shorter slats toward the sides. The arrangement of slats (34) may be asymmetric as shown in this figure or symmetric. Viewed end-on, the profile (P) of the bed plate is flat.

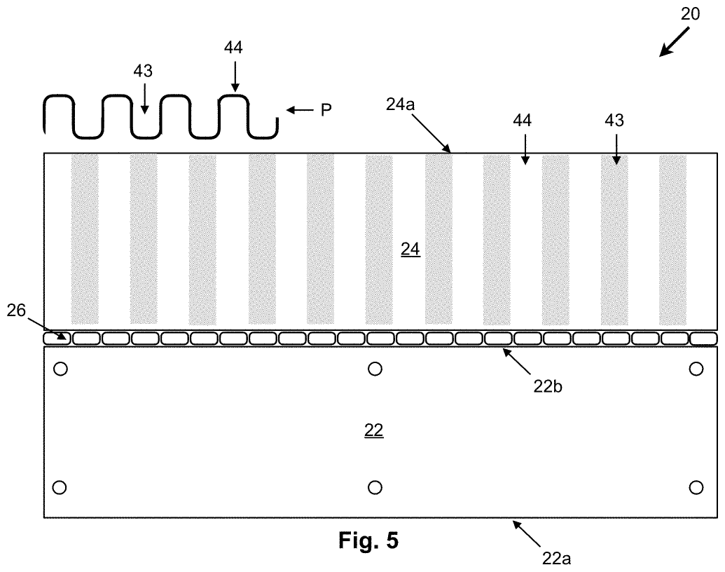

FIG. 5 is a top view of a second embodiment of a tailgate gap cover (20) showing it in an open position and a portion of an end-on profile view of the bed panel (24). Viewed end-on, the profile (P) of the bed panel leading edge (24a) is corrugated. The bed panel (24) of tailgate gap cover (20) shown in FIG. 5 comprises corrugations (43,44) comprising lowered corrugation portions (43) and raised corrugation portions (44). In some embodiments, the corrugations (43,44) may extend to within 0.5 cm of the hinged connection (26). In other embodiments, the corrugations (43,44) may end from about 1 cm to about 10 cm from the hinged connection (26). The raised (44) and lowered (43) portions of the corrugations are sized to match the corrugations of cargo bed (10). The leading edge (24a) of the bed panel shown in the figure is flat when viewed from above but may have any of a number of different shapes, including curved, cerated, and wedged shapes and combination thereof. The shape of the bed panel (24) and or the shape(s) of the slats may be symmetric or asymmetric.

The embodiments shown in the drawings are suitable for after market retrofit of a tailgate and for original equipment manufacture. Additional embodiments may comprise an inside surface of the tailgate itself acting as the gate panel (22), with the hinged connection (26) being attached to, or an integral part of, the tailgate. Other embodiments may comprise a bed panel (24) configured for attachment to the cargo bed (10) and a gate panel (22) connected by a spring loaded hinged connection (26) that tensions the gate panel (22) against the tailgate (12) so that the gate panel (22) slides on the surface of the gate when the tailgate is opened or closed and tension from the spring loaded hinged connection holds that gate panel against the tailgate. For embodiments in which the bed panel (24) is configured for attachment to the cargo bed (10), the bed panel (24) may be attached to the floor of the cargo bed or to the rear facing surface of the cargo bed (10) and the length of the gate panel (22) must be greater than the gap distance G.

While selected embodiments have been chosen to illustrate the present tailgate gap cover, various changes and modifications can be made to the selected embodiments without departing from the scope of the invention as defined in the appended claims. Components that are shown directly connected or contacting each other can have intermediate structures disposed between them. The structures and functions of one embodiment may be adopted in another embodiment and it is not necessary for all advantages to be present in a particular embodiment.

1. A device for covering a gap between a rear edge of a cargo bed and a bottom edge of a tailgate, said device comprising:
a gate panel comprising a hinge facing edge;
a bed panel comprising a hinge facing edge and an opposite facing leading edge; and
a hinged connection connecting the gate panel and the bed panel along their hinge facing edges
wherein:
the gate panel comprises attachment means for fixed attachment to the tailgate;
the bed panel is configured to slide forward and backward on the cargo bed;
a length of the bed panel is greater than a span of the gap between the rear edge of the cargo bed and the bottom edge of the tailgate when the tailgate is open; and
the gate panel, bed panel, and hinged connection are arranged such that, when the gate panel is fixed to the inside of the tailgate, moving the tailgate upward or downward causes the bed panel to slide forward or backward on the cargo bed.

2. The device of claim 1, wherein the hinged connection is a continuous hinge.

3. The device of claim 1, wherein the leading edge of the bed panel comprises a ridge or a ramp having an axis parallel with the rear edge the cargo bed, when the the device is fixed to the tailgate.

4. The device of claim 1, wherein the leading edge of the bed panel comprises a spaced slat pattern.

5. The device of claim 1, wherein the bed panel comprises corrugations having axes that are perpendicular to the rear edge the cargo bed.

6. The device of claim 1, further comprising a flexible cover attachable to top surfaces of the gate panel and bed panel to cover the hinged connection.

7. The device of claim 1, wherein a portion of one or both of the gate panel and the bed panel form a portion of the hinged connection.

8. The device of claim 1, further comprising a bed panel cover configured for attachment to the cargo bed and shaped to cover at least a portion of the bed panel when the device is attached to the cargo bed and the tailgate is closed.

9. A device for covering a gap between a rear edge of a cargo bed and a bottom edge of a tailgate, said gap cover comprising:
a gate panel comprising a hinge facing edge;
a bed panel comprising a hinge facing edge and an opposite facing leading edge; and
a hinged connection connecting said gate panel and said bed panel along their hinge facing edges
wherein:
the gate panel is an integral part of the tailgate;
the bed panel is configured to slide forward and backward on the cargo bed;
a length of the bed panel is greater than a span of said gap between the rear edge of cargo bed and the bottom edge of the tailgate when the tailgate is open; and
the gate panel, bed panel, and hinged connection are arranged such that, when the gate panel is fixed to the inside of the tailgate with the hinged connection parallel with and in apposition to the inside bottom edge of the tailgate, moving the tailgate upward or downward causes the bed panel to slide on forward or backward on the cargo bed.

10. The device of claim 9, wherein the hinged connection is a continuous hinge.

11. The device of claim 9, wherein the leading edge of the bed panel comprises a ridge or a ramp having an axis parallel with the rear edge the cargo bed, when the the device is fixed to the tailgate.

12. The device of claim 9, wherein the leading edge of the bed panel comprises a spaced slat pattern.

13. The device of claim 9, wherein the bed panel comprises corrugations having axes that are perpendicular to the rear edge the cargo bed.

14. The device of claim 9, further comprising a flexible cover attachable to top surfaces of the gate panel and bed panel to cover the hinged connection.

15. The device of claim 9, wherein a portion of one or both of the gate panel and the bed panel form a portion of the hinged connection.

16. The device of claim 9, further comprising a bed panel cover configured for attachment to the cargo bed and shaped to cover at least a portion of the bed panel when the device is attached to the cargo bed and the tailgate is closed.
